(19) United States
(12) Patent Application Publication
(10) Pub. No.: US 2024/0153653 A1
(43) Pub. Date: May 9, 2024

(54) NUCLEAR REACTOR WITH A LIQUID METAL COOLANT

(71) Applicant: "AKME-ENGINEERING", JOINT-STOCK COMPANY, Moscow (RU)

(72) Inventors: Aleksandr Vladislavovich DEDYL, Moscow (RU); Sergei Vladimirovich SAMKOTRYASOV, Podol'sk (RU); Georgii Il'ich TOSHINSKII, Moscow (RU); Urii Aleksandrovich ARSEN'EV, Podol'sk (RU); Mihail Petrovich VAHRUSHIN, Moscow (RU)

(73) Assignee: "AKME-ENGINEERING", JOINT-STOCK COMPANY, Moscow (RU)

(21) Appl. No.: 18/281,928

(22) PCT Filed: Oct. 4, 2021
(86) PCT No.: PCT/RU2021/000419

§ 371 Date: Sep. 13, 2023

(30) Foreign Application Priority Data
Mar. 15, 2021 (RU) 2021106629

(51) Int. Cl. G21C 1/32; G21C 15/02; G21C 15/28

(52) U.S. Cl. CPC G21C 1/322; G21C 15/02; G21C 15/28

(57) ABSTRACT

Embodiments of the disclosure may include a reactor vessel with a lower chamber, a core, a hot chamber, an upper chamber, and heat exchangers. In some embodiments, the hot chamber may be located above the core and may include a substantially cylindrical body. In some embodiments, the hot chamber body may include an inner shell and an additional shell installed with a gap on the outside and being concentric with the inner shell of the hot chamber, forming at least one cooling channel. In some embodiments, the connecting pipe may include an inner shell and an additional shell installed with a gap on the outside, being concentric with the inner shell of the connecting pipe and forming at least one cooling channel of the connecting pipe, where the cooling channel of the hot chamber and the connecting pipe are in communication with the outlet of the heat exchangers.

### FIELD OF THE INVENTION

The invention relates to nuclear power engineering, in particular, to ensuring the safety of nuclear reactors (NRs), primarily reactors with a heavy liquid metal coolant (HLMC) based on lead or based on lead-bismuth alloys.

When selecting the thermal engineering parameters of the NR, in particular, the maximum coolant temperature, the limiting factors are primarily the corrosion resistance of materials and the strength characteristics relating to the loading features of the structure. In this case, the maximum temperature of the coolant in liquid metal coolant reactors is usually reached at the outlet of the core. Usually, the coolant in the core is heated unevenly due to the unevenness of the coolant flow along the radius of the core and the unevenness of the energy release field throughout the core space. Thus, the structural elements located in the area of the coolant outlet from the core are impacted by the coolant with maximum temperatures and temperature inhomogeneities.

Special measures are taken to equalize the coolant heating in the core, but the efficiency of these measures is limited, and the unevenness of the coolant temperature at the outlet of the core in HLMC reactors can amount to several tens of degrees. Depending on the coolant type in the second circuit of the NR and the coolant circulation pattern in the chamber above the core and on the way to the heat exchanger or the steam generator, the coolant is mixed and the coolant temperature is gradually equalized. An increase in the reliability and safety of the reactor unit is facilitated by using special design solutions to limit the impact of adverse factors, such as high local temperatures in the chamber at the core outlet or high temperature gradients in the structural elements that limit the specified chamber.

### PRIOR ART

A pool-type HLMC reactor is known from patent RU2461085. The disadvantage of the design of this reactor type is the large volume of hot coolant, the temperature of which corresponds to the core outlet temperature. As a result, some of the in-vessel elements, the connecting elements between the drives of the control and protection system (CPS) elements and the reactivity control elements (rods or rod assemblies of the CPS) are exposed to high temperatures and/or high temperature gradients.

An integral type HLMC reactor is known from patent RU2153708. The main advantage of this reactor type is the possibility of locating a core, a pump, which circulates the coolant in the primary NR circuit, and a heat exchanger (steam generator) to remove the heat generated in the core, in a single NR vessel.

Temperature gradients in the structural elements separating the hot coolant with the core outlet temperature from the cold coolant after leaving the heat exchanger (steam generator) are of essence when designing a NR. Taking into account the fact that the difference between the maximum temperature and the minimum temperature in the primary circuit in modern HLMC NR designs is usually in the range from 100 to 150° C., it is required to develop special design solutions in order to ensure favorable operating conditions for the in-vessel structural elements separating the hot and cold coolant flows.

An important feature of the known HLMC NR is the need to control the oxygen concentration in a certain range. The presence of oxygen in the coolant is necessary to form protective oxide coatings on the steel surfaces so as to prevent the entry of metallic impurities, primarily iron, into the coolant, due to corrosion and erosion processes that take place preferably in the hot part of the primary circuit. When significant amounts of iron impurities enter the primary circuit, special systems have to be used to capture them, which complicates the NR design.

Thus, the maximum limitation of the area of surfaces in contact with the hot coolant will significantly reduce the thermal load on the in-vessel NR elements, and this is a problem that should be solved by using special design solutions.

Russian patent RU2521863 discloses a nuclear reactor with a liquid metal coolant, including a vessel, inside which a separation shell is installed, forming an annular space, and in which at least one steam generator and at least one pump are installed, each in its own shell. Inside the separation shell, in its upper part, there is a shielding plug, and in the lower part, there is a core, above which there is a hot header vertically connected to the steam generator in the middle or upper part of the steam generator through an inlet connecting pipe for dividing the liquid metal coolant flow into an upward and downward flow washing over the upper and lower parts of the steam generator, respectively.

A nuclear reactor with a liquid metal coolant according to Russian patent RU2408094 includes a hot header above the core and a cold header surrounding the hot header, separated by a separation structure, where the primary fluid circulates to cool the core. The reactor also includes at least one integrated circulation and heat exchange assembly that includes a pump, at least one heat exchanger, and a conveyor structure through which the primary fluid passes from the pump to the heat exchanger, while the latter being firmly connected to each other to form a single structure. The integrated assembly is located completely in the cold header and includes an inlet hole connected to the hot header and at least one outlet unit in the cold header.

The disadvantage of these known NRs is a significant temperature difference in the connecting pipe through which the hot coolant flow enters the steam generator or pump for subsequent cooling, which affects the design lifetime and reliability of this structural element.

The closest prior art to the claimed invention is a NR according to Russian patent RU2331939. The said patent discloses a nuclear reactor design with the predominant use of a liquid metal coolant as the primary circuit coolant. The thermal protection of the reactor vessel includes a core basket, ring steel shells, installed and fixed in the basket, and a separation shell fixed on the vessel bottom. The heat shield includes boron carbide blocks; they are located behind the separation shell to form a layered annular screen along the entire height of the core. The gaps between the said blocks of a single layer are filled with the next layer blocks.

The disadvantage of the closest prior art is the rigid fixing of the shells in the reactor vessel, which, when the shells come into contact with the flow of hot coolant leaving the core, will create a significant thermal load in the junction points of the elements and can result in coolant leaks. Rigid fixation of shells in contact with the hot coolant flow also complicates routine maintenance and repairs.

### DISCLOSURE OF THE INVENTION

The technical problems solved in the claimed invention are to reduce the volume and surface area of the in-vessel structural elements of the reactor in contact with the hot coolant flow, to ensure thermal insulation of the hot chamber and a favorable temperature conditions for the in-vessel structural elements so that temperature differences are limited to values at which the temperature stresses do not exceed the yield strength, as well as to ensure ease of assembly and inspection of coolant leaks in detachable joints.

The technical result of the claimed invention is to reduce the thermal load on the elements of the hot chamber, first of all, the hot chamber body and the connecting pipes for removing the hot coolant, including smoothing and reducing the temperature gradient occurring in these elements, and, as a consequence, increase their design lifetime, as well as the design lifetime of the NR in general.

The technical problems are solved, and the claimed technical result is achieved by the fact that an integral type nuclear reactor with a liquid metal coolant includes a reactor vessel with a lower chamber, a core, a hot chamber, an upper chamber, and heat exchangers, wherein the hot chamber is located above the core and includes the hot chamber body, which is essentially cylindrical with connecting pipes for removing the hot coolant coming from the core to the heat exchangers. The hot chamber body includes an inner shell of the hot chamber and at least one additional shell of the hot chamber, installed with a gap on the outside and being concentric with the inner shell of the hot chamber, in contact with the cold coolant from the outside and forming at least one channel communicating with the cold coolant. In this case, each connecting pipe includes an inner shell of the connecting pipe and at least one additional shell of the connecting pipe, installed with a gap on the outside and being concentric with the inner shell of the connecting pipe, in contact with the cold coolant from the outside and forming at least one channel communicating with the cold coolant. The cold coolant enters at least one said channel of the hot chamber and at least one said channel of the connecting pipe from the outlet of the heat exchangers.

The described design of the hot zone of the NR makes it possible to evenly distribute the temperature over the hot chamber body and the connecting pipe, as well as to reduce the thermal load on these structural elements of the NR, which has a positive effect on their reliability and design lifetime.

Specific embodiments of the invention are also possible, in which the set problems are also solved and the claimed technical result is achieved.

So, to additionally ensure a uniform temperature distribution over the hot chamber body and the connecting pipe, through holes are made in at least one additional shell of the hot chamber and/or in at least one additional shell of the connecting pipe. These through holes ensure an additional coolant flow in cases where the length of the channels connected to the chambers with the cold coolant is significant and prevents the coolant flow into them. The coolant flow is necessary, among other things, to maintain the required concentration of oxygen dissolved in the coolant in the channels. The hole shape can be arbitrary and is determined only by the functionality of these holes. The oxygen concentration requirements are determined by the known ratios.

The intensity of the coolant flow passing through the gaps between the shells is adjusted, among other things, by the width of the gaps between the shells and the holes in the additional shells. The said intensity is selected in such a way as to make sure a uniform distribution of the temperature difference between the inner shell and the corresponding additional shells, preferably according to a linear law.

To ensure the convenience and reliability of the assembly, the compensation of the temperature movements of the elements, the mating of the plug, the inner shell of the hot chamber, and the inner shell of the connecting pipe, as well as to prevent the ingress of hot coolant into the cavities between the additional shells and/or the inner shells and the corresponding additional shells, the hot chamber design may include seals with piston rings. In particular, it is preferable that at least one first sealing piston ring is located between the inner shell of the hot chamber and the plug, at least one second sealing piston ring is located between the inner shell of the hot chamber and the adjacent additional shell of the hot chamber, and at least one third sealing piston ring is located between the inner shell of the connecting pipe and the adjacent additional shell of the connecting pipe.

Piston rings are preferably made of high-strength and corrosion-resistant material, for example, gray cast iron with flake graphite, doped with chromium and silicon.

In the vertical direction, above the core, the hot chamber is limited with a plug. The preferred shape of the plug is a cone trapezoid, which makes it possible to smooth the flow direction of the hot coolant leaving the core and to turn the flow rate by about 90° to facilitate its passage from the hot chamber to the connecting pipe for removing the hot coolant, which has a positive effect on the distribution of the heat load on the components of the hot chamber. In particular, the plug can be made of at least two disc elements installed with a gap one above the other and made of steel.

Further, possible embodiments of the invention are disclosed in more detail with reference to the figures.

### BRIEF DESCRIPTION OF DRAWINGS

FIG. 1 shows a 3D view of an integral type reactor according to the invention.

FIG. 2 shows a detail of the 3D view of the reactor.

FIG. 3 shows section 1-1 of an integral type reactor according to the invention.

FIG. 4 shows section 2-2 of an integral type reactor according to the invention.

FIG. 5 shows the section of the connecting pipe for removing the hot coolant flow.

FIG. 6 shows an embodiment of the invention with the only upwards removal of the hot coolant.

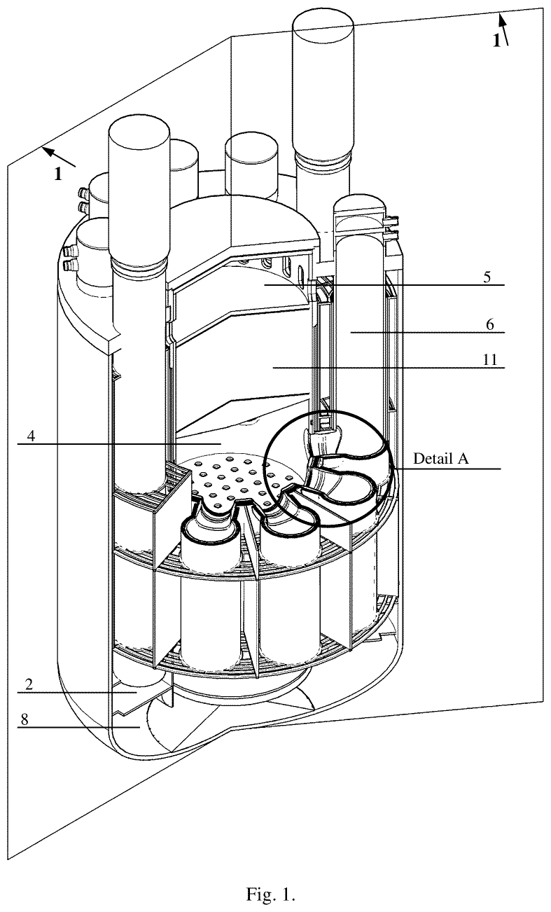

The Numbers in the Figures Refer to the Following:
1: reactor vessel;
2: lower chamber;
3: core;
4: hot chamber;
5: upper chamber;
6: heat exchanger (steam generator);
7: pump;
8: coolant supply channel;
9: connecting pipe;
10: hot chamber body;
11: plug;
12: inner shell of the hot chamber;
13: additional shell of the hot chamber;
14: cooling channel of the hot chamber;
15: inner shell of the connecting pipe;
16: additional shell of the connecting pipe;
17: cooling channel of the connecting pipe;
18: heat exchanger outlet;
19: the first sealing piston ring;
20: the third sealing piston ring;
21: plug disc element.

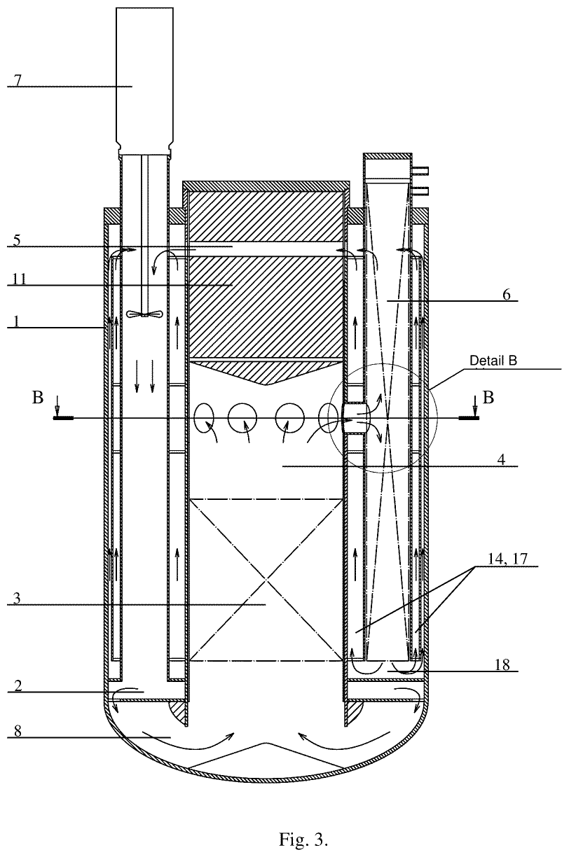

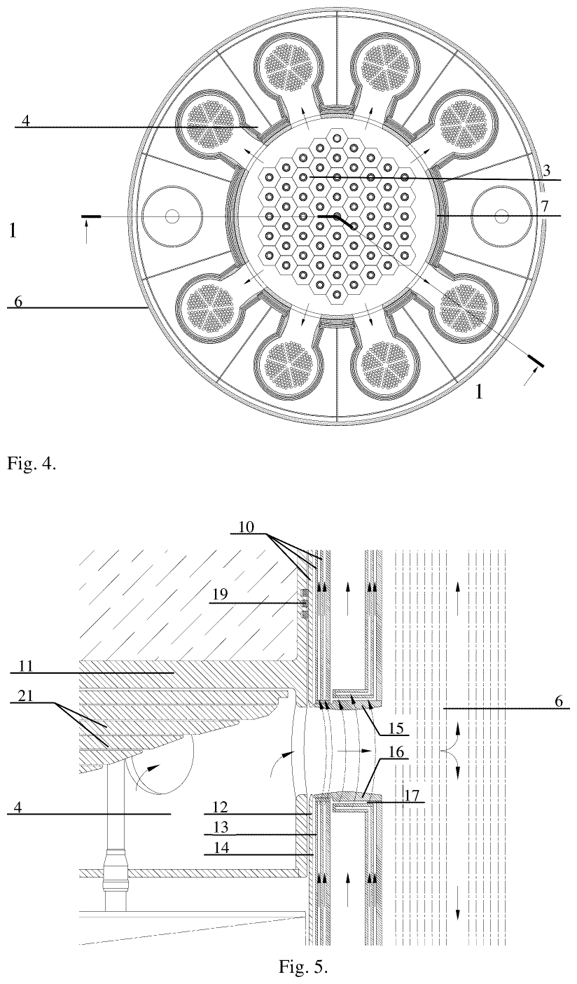

In the general case, the nuclear reactor more simply shown in FIG. 3, includes a reactor vessel 1, which houses a lower chamber 2, a core 3, a hot chamber 4, an upper chamber 5, and heat exchangers (steam generators) 6. The purpose of each of these NR components is well known to a person skilled in the art and does not require additional explanations; therefore, only the features of the performance of individual NR components relating to this invention will be described.

In the figures, the arrows show the coolant flow directions.

The cold coolant is supplied by the pump 7 to the lower chamber 2, from where it enters the inlet of the core 3 through the coolant supply channels 8. In the core 3, the coolant is heated and enters the hot chamber 4, located above the core 3, with the core outlet temperature. Next, the hot coolant is directed to the connecting pipes 9 for removing the hot coolant, which provide the supply of the hot coolant flow to the heat exchangers (steam generators) 6.

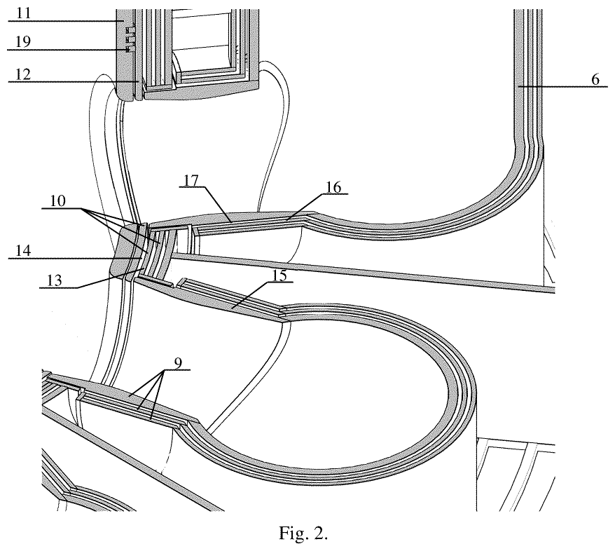

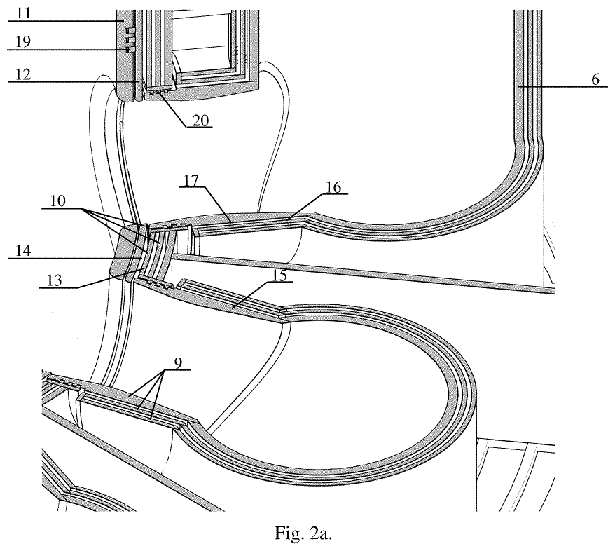

The hot chamber 4 (FIG. 2) includes a hot chamber body 10 of a substantially cylindrical shape with connecting pipes 9 for removing the hot coolant coming from the core to the heat exchangers 6, and a plug 11.

According to the invention, the hot chamber body 10 includes an inner shell 12 of the hot chamber and at least one additional shell 13 of the hot chamber. The additional shells 13 of the hot chamber are installed with a gap outside the inner shell 12 of the hot chamber and are concentric with it, therefore forming at least one cooling channel 14 of the hot chamber.

According to the invention, each connecting pipe 9 also includes an inner shell 15 of the connecting pipe and at least one additional shell 16 of the connecting pipe installed with a gap on the outside, being concentric with the inner shell 15 of the connecting pipe and forming at least one cooling channel 17 of the connecting pipe.

The cooling channels 14 of the hot chamber and the cooling channels 17 of the connecting pipe are in communication with the outlets 18 (FIG. 3) of the heat exchangers to direct the cooled coolant flow into the said cooling channels 14, 17.

FIG. 3 shows that downstream the hot coolant inlet to the heat exchanger 6, the flow is divided into two parts: the first part of the hot coolant flow, moving upwards, is cooled by the coolant of the second circuit and enters the upper chamber 5. The second part of the hot coolant flow, moving down, is also cooled by the coolant of the second circuit and enters the heat exchanger outlet 18, where it turns around and moves upwards along the cooling channels 14, 17.

This movement of the coolant, including its passage through the cooling channels 14, 17, facilitates the equalization of the temperature across the cross-section of the hot chamber body 10 and the connecting pipe and the reduction of the thermal load on them and the resulting thermal stresses, which affects the reliability of operation and the design lifetime of these structural NR elements.

The size of the gaps between the inner shells 12, 15 and the corresponding additional shells 13, 16, as well as between the corresponding additional shells 13, 16, is selected in such a way that as a result of thermal expansion and displacements of the structural NR elements, there is no direct contact between these shells, so that in any case there is a guaranteed gap for the circulation of the coolant in the cooling channels 14, 17 between the said shells.

The flow rate of the coolant supplied to the cooling channels 14, 17 is calculated so that the heat transfer along the cooling channels 14, 17 is significantly less than the heat transfer between the inner shells 12, 15 and the corresponding additional shells 13, 16, as well as between the corresponding additional shells 13, 16.

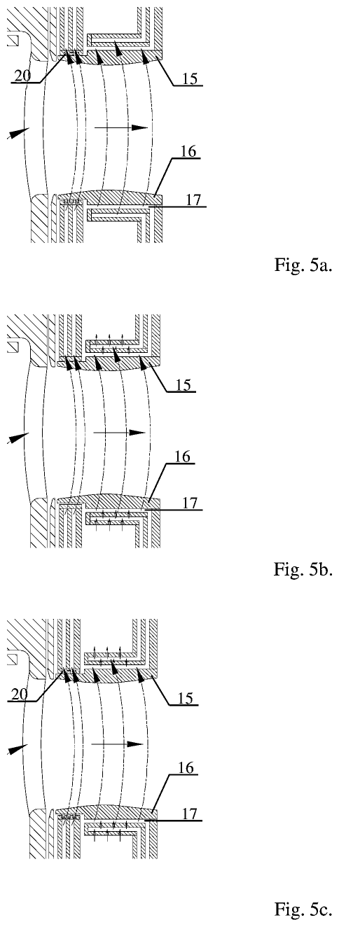

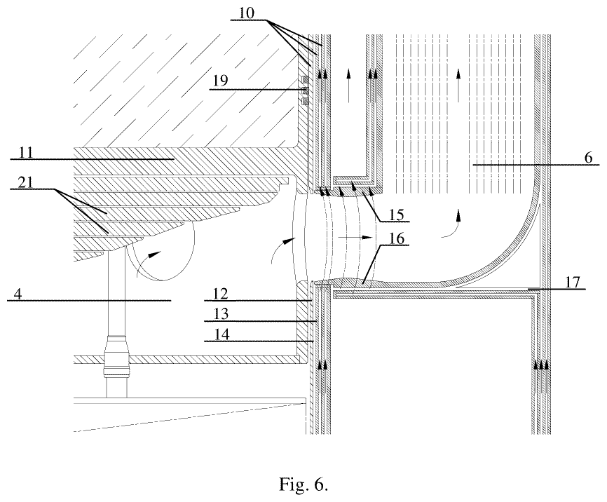

In addition, according to this invention, through holes can be made in at least one additional shell 13 of the hot chamber and/or in at least one additional shell 16 of the connecting pipe (FIG. 5b, 5c). The said through holes provide the hot coolant flow, as shown by the arrows in the figures. The hole shape can be arbitrary and is determined only by the functionality of these holes. The intensity of the coolant flow passing through the cooling channels 14, 17 is adjusted, among other things, with the said through holes in the additional shells. This intensity is selected in such a way as to make sure a uniform distribution of the temperature difference between the inner shell 12, 15 and the corresponding additional shells 13, 16, preferably according to a linear law.

To avoid the occurrence of high stresses during the movements of the structural NR elements as a result of thermal expansion, there is no strong connection between inner shells 12, 15 and the corresponding mating NR components. In this case, movable seals should be provided, the preferred embodiment of which is piston ring-type seals.

Thus, at least one first sealing piston ring 19 may be located between the inner shell 12 of the hot chamber and the plug 11; at least one second sealing piston ring (not shown in the figures) may be located between the inner shell 13 of the hot chamber and the adjacent additional shell of the hot chamber: at least one third sealing piston ring 20 may be located between the inner shell 16 of the connecting pipe and the adjacent additional shell of the connecting pipe.

The most preferred material of these piston rings is a high-strength and corrosion-resistant material, in particular, gray cast iron with flake graphite, alloyed with chromium and silicon.

The plug 11 limits the hot chamber 4 in the vertical direction, above the core. The preferred shape of the plug 11 is a cone trapezoid, which makes it possible to smooth the flow direction of the hot coolant leaving the core 3 and to turn the flow rate by about 90° to facilitate its passage from the hot chamber 4 to the connecting pipe 9 for removing the hot coolant, which has a positive effect on the distribution of the heat load on the components of the hot chamber 4. In particular, the plug 11 can be made of at least two disc elements 21 installed with a gap one above the other and made of steel.

Thus, this invention makes it possible to reduce the volume and surface area of the in-vessel structural nuclear reactor elements that are in contact with the hot coolant flow, to ensure thermal insulation of the hot chamber and a favorable temperature conditions for these elements, and to ensure ease of assembly and inspection of coolant leaks in detachable joints. As a result, the temperature differences in these elements are limited to values at which the temperature stresses do not exceed the yield strength, the thermal load on them is reduced, primarily on the hot chamber body and the connecting pipes for removing the hot coolant, and their design lifetime is increased.

1. An integral type nuclear reactor with a liquid metal coolant, including:
a reactor vessel with a lower chamber, a core, a hot chamber, an upper chamber, and heat exchangers, wherein the hot chamber is located above the core and includes:
a hot chamber body of a substantially cylindrical shape with connecting pipes for removing the hot coolant, supplied from the core to the heat exchangers, and a plug, wherein:
the connecting pipes are washed from the outside by the cold coolant from the outlet of the heat exchangers;
the hot chamber body includes an inner shell of the hot chamber and at least one additional shell of the hot chamber, installed with a gap on the outside and being concentric with the inner shell of the hot chamber and forming at least one channel of the hot chamber; and
each connecting pipe includes an inner shell of the connecting pipe and at least one additional shell of the connecting pipe, installed with a gap on the outside and being concentric with the inner shell of the connecting pipe and forming at least one at least one channel of the connecting pipe, and at least one channel of the hot chamber and at least one channel of the connecting pipe are in communication with the outlet of the heat exchangers to direct the cold coolant flow into the said channels.

2. The nuclear reactor according to claim 1, wherein through holes are made in at least one additional shell of the hot chamber and/or at least one additional shell of the connecting pipe.

3. The nuclear reactor according to claim 1, wherein at least one first sealing piston ring is located between the inner shell of the hot chamber and the plug,
at least one second sealing piston ring is located between the inner shell of the hot chamber and the additional shell of the hot chamber adjacent to it, and at least one third sealing piston ring is located between the inner shell of the connecting pipe and the adjacent additional shell of the connecting pipe.

4. The nuclear reactor according to claim 3, wherein the said sealing piston rings and/or plug are made of a high-strength and corrosion-resistant material.

5. The nuclear reactor according to claim 4, wherein the specified material is gray cast iron with flake graphite alloyed with chromium and silicon.

6. The nuclear reactor according to claim 1, wherein the plug includes at least two-disc elements.

7. The nuclear reactor according to claim 2, wherein the plug includes at least two-disc elements.

8. The nuclear reactor according to claim 3, wherein the plug includes at least two-disc elements.

9. The nuclear reactor according to claim 4, wherein the plug includes at least two-disc elements.

10. The nuclear reactor according to claim 5, wherein the plug includes at least two-disc elements.
